(19) United States
(12) Patent Application Publication
(10) Pub. No.: US 2007/0248747 A1
(43) Pub. Date: Oct. 25, 2007

(54) Glass circuit board and manufacturing method thereof

(75) Inventor: Feng-Li Lin, Taishan Township (TW)

Correspondence Address: BIRCH STEWART KOLASCH & BIRCH, PO BOX 747, FALLS CHURCH, VA, 22040-0747, US

(73) Assignee: GIGNO TECHNOLOGY CO., LTD., Taipei City (TW)

(21) Appl. No.: 11/785,025

(22) Filed: Apr. 13, 2007

(30) Foreign Application Priority Data
Apr. 14, 2006 (TW) 095113285

(51) Int. Cl. B05D 5/12

(52) U.S. Cl. 427/108

(57) ABSTRACT

A method of manufacturing a glass circuit board includes the steps of: providing a glass substrate; forming a patterned metal layer on a surface of the glass substrate to expose a part of the surface; forming an insulating layer, with at least one opening, on the surface of the glass substrate and the patterned metal layer; and forming a metal connecting layer in the opening of the insulating layer. A glass circuit board manufactured by the method includes a glass substrate, a patterned metal layer, an insulating layer and a metal connecting layer. The glass substrate has a surface. The patterned metal layer is disposed on the surface of the glass substrate. The insulating layer is disposed on a part of the surface of the glass substrate and the patterned metal layer, and has at least one opening. The metal connecting layer is disposed in the opening of the insulating layer.

### CROSS REFERENCE TO RELATED APPLICATIONS

This Non-provisional application claims priority under 35 U.S.C. §119(a) on Patent Application No(s). 095113285 filed in Taiwan, Republic of China on Apr. 14, 2006, the entire contents of which are hereby incorporated by reference.

### BACKGROUND OF THE INVENTION

1. Field of Invention

The invention relates to a circuit substrate and a manufacturing method thereof, and, in particular, to a glass circuit board and a manufacturing method thereof.

2. Related Art

In today's information society, the market demand for multimedia applications is constantly expanding. Integrated circuit (IC) technology has been developed according to trends in digital devices, networks, local connections, and human interface technology. To satisfy the above-mentioned demands, electronic devices have to satisfy various requirements, such as the high-speed processing, the multi-functionality, integration, compactness, light weight, and low price. Thus, the integrated circuit package technology is approaching finer micro-structure and higher density. High density IC package technology, such as ball grid array (BGA) packages, chip-scale packages (CSP), flip chip packages and multi-chip modules (MCM), have been introduced. The IC package density represents the number of pins disposed in a unit area.

Because the integrated circuit has been made thin and light and the number of pins is increased even as the chip is reduced, the pad pitch between bonding pads corresponding to pins and the size of the bonding pad can be reduced. Correspondingly, the trace pitch between metal traces on a circuit board has to be reduced in order to accommodate the trend in miniaturized electronic products. Thus, the fine pitch technology using the trace pitch smaller than 50 microns has been developed. However, a precondition of the fine pitch technology is that a metal layer having the thickness of about 0.3 to 0.5 microns and good mechanical intensity has to be manufactured. In general, a vacuum sputtering process has to be utilized in order to obtain the required properties.

An organic resin material or a ceramic material serves as the material of the substrate in the conventional circuit board. A circuit board with a substrate made of the organic resin material cannot withstand the high temperatures of the vacuum sputtering process, and the coefficient of thermal expansion (CTE) of the resin material is very great. So, the metal trace formed on the substrate tends to crack. The ceramic substrate can withstand high temperatures. As in the circuit board having the substrate made of the organic resin material, however, the surface of the ceramic substrate has many voids. So, it is difficult to form thin and continuous metal layers or traces. Thus, it is difficult to apply fine pitch technology to the typical circuit board, and when the technology of the fine pitch smaller than 35 microns is utilized, the increased cost grows exponentially and the actual requirements cannot be satisfied.

As mentioned hereinabove, it is an important subject of the invention to provide a circuit substrate and a manufacturing method thereof, in which the fine pitch technology can be easily implemented without increasing the cost significantly.

### SUMMARY OF THE INVENTION

In view of the foregoing, the invention is to provide a glass circuit board and a manufacturing method thereof, which may be applied to precise pitch technology.

To achieve the above, the invention discloses a method of manufacturing a glass circuit board. The method includes the steps of: providing a glass substrate; forming a patterned metal layer on a surface of the glass substrate to expose a part of the surface; forming an insulating layer, with at least one opening, on the surface of the glass substrate and the patterned metal layer; and forming a metal connecting layer on the opening of the insulating layer.

To achieve the above, the invention also discloses a method of manufacturing a glass circuit board. The method includes the steps of: providing a glass substrate; forming a patterned metal layer on a surface of the glass substrate to expose a part of the surface; forming an insulating layer, with at least one opening, on the surface of the glass substrate and the patterned metal layer; and forming a metal connecting layer on the insulating layer and the opening.

In addition, the invention discloses a glass circuit board including a glass substrate, a patterned metal layer, an insulating layer and a metal connecting layer. The glass substrate has a surface. The patterned metal layer is disposed on the surface of the glass substrate. The insulating layer with at least one opening is disposed on the surface of the glass substrate and the patterned metal layer. The metal connecting layer is disposed in the opening of the insulating layer.

To achieve the above, the invention also discloses a glass circuit board including a glass substrate, a patterned metal layer, an insulating layer and a patterned metal connecting layer. The glass substrate has a surface. The patterned metal layer is disposed on the surface of the glass substrate. The insulating layer with at least one opening is disposed on the surface of the glass substrate and the patterned metal layer. The patterned metal connecting layer is disposed on a part of the insulating layer and in the opening.

As mentioned hereinabove, a conventional printed circuit board having a substrate made of a resin material is replaced with a glass substrate in the glass circuit board and the manufacturing method thereof according to the invention. Thus, the glass circuit board can be easily applied to the precise pitch technology so as to reduce the size of the circuit board and thus achieve the lightness, thin-profile, and compactness requirements of the electronic product using the glass circuit board.

### BRIEF DESCRIPTION OF THE DRAWINGS

The invention will become more fully understood from the detailed description given herein below illustration only, and thus is not limitative of the present invention, and wherein:

FIG. 1 is a flow chart showing a method of manufacturing a glass circuit board according to a first embodiment of the invention;

FIGS. 2A to 2F are one set of schematic illustrations showing the glass circuit board corresponding to the flow of FIG. 1;

FIGS. 3A and 3B are another set of schematic illustrations showing the glass circuit board corresponding to the flow of FIG. 1;

FIG. 4 is a flow chart showing a method of manufacturing a glass circuit board according to a second embodiment of the invention; and

FIGS. 5A to 5C are one set of schematic illustrations showing the glass circuit board corresponding to the flow of FIG. 4.

### DETAILED DESCRIPTION OF THE INVENTION

The present invention will be apparent from the following detailed description, which proceeds with reference to the accompanying drawings, wherein the same references relate to the same elements.

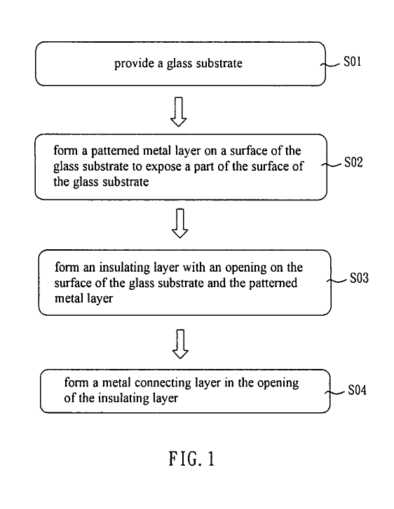

Referring to FIG. 1, a method of manufacturing a glass circuit board according to a first embodiment of the invention includes steps S01 to S04.

In step S01, a glass substrate 11 is provided. In step S02, a patterned metal layer is formed on a surface of the glass substrate 11 to expose a part of the surface of the glass substrate. The material of the patterned metal layer is selected from at least one of the group consisting of titanium, a titanium-tungsten alloy, aluminum, a chromium-nickel alloy, copper, a nickel-vanadium alloy, a chromium-copper alloy, a nickel-titanium alloy and molybdenum. In this embodiment, the material of the patterned metal layer is copper.

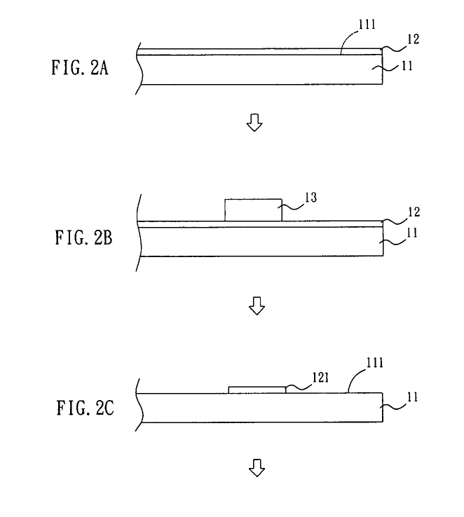

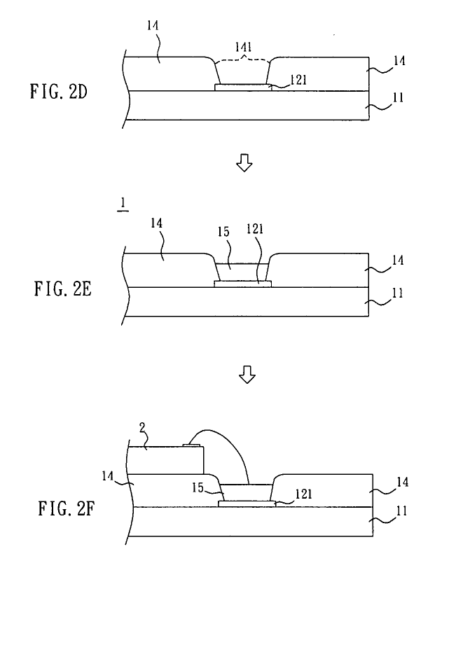

In this embodiment, the step of forming the patterned metal layer includes the following sub-steps. As shown in FIG. 2A, a metal layer 12 is formed on a surface 111 of the glass substrate 11. Then, as shown in FIG. 2B, a resist layer is formed on the metal layer 12 and patterned to form a patterned resist layer 13. Next, as shown in FIG. 2C, the metal layer 12 is etched using the patterned resist layer 13 as a mask to remove a part of the metal layer 12 and form a patterned metal layer 121 with the part of the surface 111 of the glass substrate 11 being exposed.

In step S03, as shown in FIG. 2D, an insulating layer 14 with an opening 141 is formed on the surface 111 of the glass substrate 11 and the patterned metal layer 121. In this embodiment, the patterned metal layer 121 is exposed from the opening 141 of the insulating layer 14.

In step S04, as shown in FIG. 2E, a metal connecting layer 15 is formed in the opening 141 of the insulating layer 14 so that a glass circuit board 1 is formed. The material of the metal connecting layer 15 may be, without limitation to, at least one of the group consisting of titanium, nickel, vanadium, copper, aluminum and gold. In this embodiment, the material of the metal connecting layer 15 may be the copper, which is the same as that of the patterned metal layer 121.

As shown in FIG. 2F, an electronic device 2 or a connecting terminal (not shown) may be disposed on the metal connecting layer 15 by way of surface mount technology (SMT), wire bonding or flip-chip bonding in this embodiment. The electronic device 2 may be an active device or a passive device. Thus, the electronic device 2 may be a resistor, a capacitor, an inductor, a transistor, a diode, a chip or a bare chip.

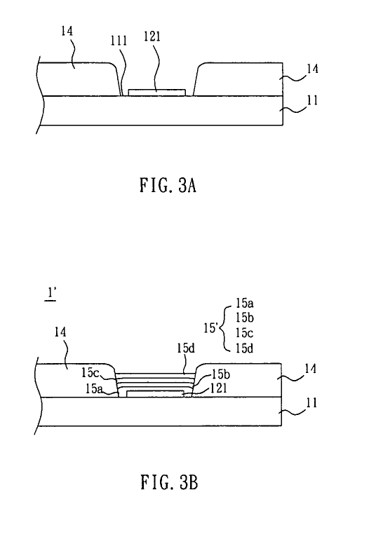

As shown in FIG. 3A, the patterned metal layer 121 and the part of the surface 111 of the glass substrate 11 may be exposed from the opening 141 of the insulating layer 14 according to the actual requirement. As shown in FIG. 3B, a metal connecting layer 15′ is then formed on the patterned metal layer 121 and the part of the surface 111 of the glass substrate 11 exposed from the opening 141. The metal connecting layer 15′ includes a titanium metal layer 15a, a nickel metal layer 15b, a vanadium metal layer 15c and a copper metal layer 15d in order to form a glass circuit board 1′.

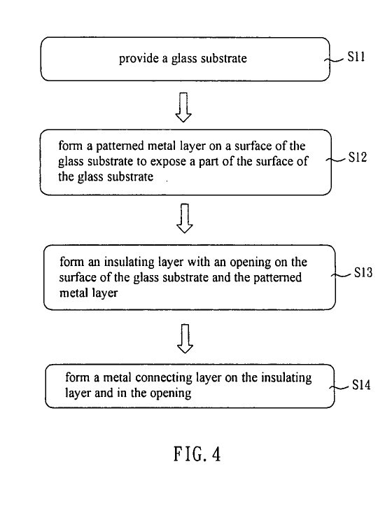

FIG. 4 shows the method of manufacturing the glass circuit board according to the second embodiment of the invention. The method includes steps S11 to S14.

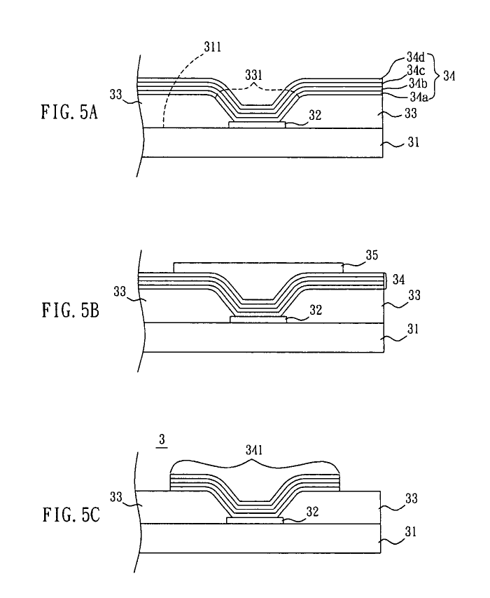

Steps S11 to S13 are the same as the steps S01 to S03. As shown in FIG. 5A, a glass substrate 31 is provided, and a patterned metal layer 32 is formed on a surface 311 of the glass substrate 31 to expose a part of the surface 311 of the glass substrate 31. Next, an insulating layer 33 is formed on the part of the surface 311 of the glass substrate 31 and the patterned metal layer 32, and at least one opening 331 is formed on the insulating layer. The material of the patterned metal layer and the method of forming the patterned metal layer are the same as those of the first embodiment, and detailed descriptions thereof will be omitted.

In step S14, as shown in FIG. 5A, a metal connecting layer 34 is formed on the insulating layer 33 and in the opening 331. The metal connecting layer 34 may have a single-layer structure or a multi-layer structure, and the material thereof may be, without limitation to, at least one of the group consisting of titanium, nickel, vanadium, copper, aluminum and gold. In this embodiment, the metal connecting layer 34 includes a titanium metal layer 34a, a nickel metal layer 34b, a vanadium metal layer 34c and a copper metal layer 34d in ascending order.

As shown in FIGS. 5B and 5C, the method of manufacturing the glass circuit board according to this embodiment further includes the steps of forming a patterned resist layer 35 on the metal connecting layer 34 and etching the metal connecting layer 34 with the patterned resist layer 35 serving as the mask to form a patterned metal connecting layer 341 and thus a glass circuit board 3. In addition, similar to the first embodiment, an electronic device or a connecting terminal may be disposed on the patterned metal connecting layer 341 by way of surface mount technology (SMT), wire bonding or flip-chip bonding in the second embodiment. Also, the electronic device may be an active device or a passive device. Thus, the electronic device may be a resistor, a capacitor, an inductor, a transistor, a diode, a chip or a bare chip.

The method of manufacturing the glass circuit board according to the preferred embodiment of the invention has been described in detail. It is to be noted that the structure and the composition of the glass circuit board also have been described, so no repeated description for the glass circuit board will be made.

In summary, the conventional printed circuit board having a substrate made of a resin material is replaced with a glass substrate in the glass circuit board and the manufacturing method thereof according to the invention. Compared with the resin substrate and the ceramic substrate, the glass substrate can withstand high temperature and has the fewer surface voids. Thus, the glass circuit board can be easily applied to the precise pitch technology in order to reduce the size of the circuit board and thus satisfy the lightness, thin-profile, and compactness requirements of electronic product using the above described glass circuit board.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A method of manufacturing a glass circuit board, the method comprising the steps of:
providing a glass substrate;
forming a patterned metal layer on a surface of the glass substrate to expose a part of the surface;
forming an insulating layer, with at least one opening, on the surface of the glass substrate and the patterned metal layer; and
forming a metal connecting layer in the opening of the insulating layer.

2. The method according to claim 1, wherein the patterned metal layer is exposed from the opening of the insulating layer.

3. The method according to claim 1, wherein the patterned metal layer and the part of the surface of the glass substrate are exposed from the opening of the insulating layer.

4. The method according to claim 1, wherein a material of the patterned metal layer is selected from at least one of the group consisting of titanium, a titanium-tungsten alloy, aluminum, a chromium-nickel alloy, copper, a nickel-vanadium alloy, a chromium-copper alloy, a nickel-titanium alloy and molybdenum.

5. The method according to claim 1, wherein a material of the metal connecting layer is selected from at least one of the group consisting of titanium, nickel, vanadium, copper, aluminum and gold.

6. The method according to claim 1, wherein the step of forming the patterned metal layer comprises:
forming a metal layer on the surface of the glass substrate;
forming a resist layer on the metal layer and patterning the resist layer to form a patterned resist layer; and
etching the metal layer with the patterned resist layer serving as a mask to remove a part of the metal layer, to form the patterned metal layer and to expose with the part of the surface of the glass substrate.

7. The method according to claim 1, further comprising the step of:
disposing an electronic device or a connecting terminal on the metal connecting layer by way of surface mount technology, wire bonding or flip-chip bonding.

8. The method according to claim 7, wherein the electronic device is an active device or a passive device.

9. The method according to claim 7, wherein the electronic device is a resistor, a capacitor, an inductor, a transistor, a diode, a chip or a bare chip.

10. A method of manufacturing a glass circuit board, the method comprising the steps of:
providing a glass substrate;
forming a patterned metal layer on a surface of the glass substrate to expose a part of the surface;
forming an insulating layer, with at least one opening, on the surface of the glass substrate and the patterned metal layer; and
forming a metal connecting layer on the insulating layer and in the opening.

11. The method according to claim 10, wherein the patterned metal layer is exposed from the opening of the insulating layer.

12. The method according to claim 10, wherein the patterned metal layer and the part of the surface of the glass substrate are exposed from the opening of the insulating layer.

13. The method according to claim 10, wherein a material of the patterned metal layer is selected from at least one of the group consisting of titanium, a titanium-tungsten alloy, aluminum, a chromium-nickel alloy, copper, a nickel-vanadium alloy, a chromium-copper alloy, a nickel-titanium alloy and molybdenum.

14. The method according to claim 10, wherein a material of the metal connecting layer is selected from at least one of the group consisting of titanium, nickel, vanadium, copper, aluminum and gold.

15. The method according to claim 10, wherein the step of forming the patterned metal layer comprises:
forming a metal layer on the surface of the glass substrate;
forming a resist layer on the metal layer and patterning the resist layer to form a patterned resist layer; and
etching the metal layer with the patterned resist layer serving as a mask to remove a part of the metal layer, to form the patterned metal layer and to expose with the part of the surface of the glass substrate.

16. The method according to claim 10, further comprising the steps of:
forming a patterned resist layer on the metal connecting layer; and
etching the metal connecting layer with the patterned resist layer serving as a mask to form a patterned metal connecting layer.

17. The method according to claim 16, further comprising the step of:
disposing an electronic device or a connecting terminal on the patterned metal connecting layer by way of surface mount technology, wire bonding or flip-chip bonding.

18. The method according to claim 17, wherein the electronic device is an active device or a passive device.

19. The method according to claim 17, wherein the electronic device is a resistor, a capacitor, an inductor, a transistor, a diode, a chip or a bare chip.

20. A glass circuit board, comprising:
a glass substrate having a surface;
a patterned metal layer disposed on the surface of the glass substrate;
an insulating layer, which is disposed on the surface of the glass substrate and the patterned metal layer, and has at least one opening; and
a metal connecting layer disposed in the opening of the insulating layer.

21. The glass circuit board according to claim 20, wherein a material of the patterned metal layer is selected from at least one of the group consisting of titanium, a titanium-tungsten alloy, aluminum, a chromium-nickel alloy, copper, a nickel-vanadium alloy, a chromium-copper alloy, a nickel-titanium alloy and molybdenum.

22. The glass circuit board according to claim 20, wherein a material of the metal connecting layer is selected from at least one of the group consisting of titanium, nickel, vanadium, copper, aluminum and gold.

23. The glass circuit board according to claim 20, further comprising an electronic device or a connecting terminal electrically connected with the metal connecting layer.

24. The glass circuit board according to claim 23, wherein the electronic device or the connecting terminal is disposed on the metal connecting layer by way of surface mount technology, wire bonding or flip-chip bonding.

25. The glass circuit board according to claim 23, wherein the electronic device is an active device or a passive device.

26. The glass circuit board according to claim 23, wherein the electronic device is a resistor, a capacitor, an inductor, a transistor, a diode, a chip or a bare chip.

27. A glass circuit board, comprising:
a glass substrate having a surface;
a patterned metal layer disposed on the surface of the glass substrate;
an insulating layer, which is disposed on the surface of the glass substrate and the patterned metal layer, and has at least one opening; and
a patterned metal connecting layer disposed on a part of the insulating layer and in the opening.

28. The glass circuit board according to claim 27, wherein a material of the patterned metal layer is selected from at least one of the group consisting of titanium, a titanium-tungsten alloy, aluminum, a chromium-nickel alloy, copper, a nickel-vanadium alloy, a chromium-copper alloy, a nickel-titanium alloy and molybdenum.

29. The glass circuit board according to claim 27, wherein a material of the metal connecting layer is selected from at least one of the group consisting of titanium, nickel, vanadium, copper, aluminum and gold.

30. The glass circuit board according to claim 27, further comprising an electronic device or a connecting terminal electrically connected with the metal connecting layer.

31. The glass circuit board according to claim 30, wherein the electronic device or the connecting terminal is disposed on the metal connecting layer by way of surface mount technology, wire bonding or flip-chip bonding.

32. The glass circuit board according to claim 30, wherein the electronic device is an active device or a passive device.

33. The glass circuit board according to claim 30, wherein the electronic device is a resistor, a capacitor, an inductor, a transistor, a diode, a chip or a bare chip.
